(19) United States
(12) Patent Application Publication
(10) Pub. No.: US 2023/0381878 A1
(43) Pub. Date: Nov. 30, 2023

(54) Portable Thermal Cutting Device

(71) Applicant: Edison Cook, Denton, TX (US)

(72) Inventor: Edison Cook, Denton, TX (US)

(21) Appl. No.: 17/824,424

(22) Filed: May 25, 2022

(51) Int. Cl. B23K 7/00; H01M 50/172; H01M 50/55

(52) U.S. Cl. CPC B23K 7/002; H01M 50/172; H01M 50/55; H01M 2220/30

(57) ABSTRACT

A portable thermal cutting device for portably dispensing and igniting a thermally reactive substance to cut a workpiece includes a hollow tube containing a reactive substance comprising a mixture of a metallic oxide powder and a reducing agent such that a user can dispense the reactive substance. An electrical power module with an anode and a cathode is coupled to the tube, wherein the anode and the cathode are simultaneously positionable such that the anode is proximate the cathode and both the anode and the cathode abut the dispensed reactive substance, thereby igniting the reactive substance for cutting a workpiece.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to chemical cutting devices and more particularly pertains to a new chemical cutting device for portably dispensing and igniting a thermally reactive substance to cut a workpiece.

### (2) Description of Related Art Including Information Disclosed Under 37 CFR 1.97 and 1.98

The prior art relates to devices which use a mixture of a metal oxide and a reducing agent, also called thermite, for metal cutting and welding operations in various forms. For example, some devices in the prior art pertain to a torch directing the high temperatures produced by an ignited oxidation-reduction reaction of the thermite onto a focused area sufficient for a skilled craftsperson to precisely cut or weld a workpiece. These devices function with the user cutting during an ongoing oxidation-reduction reaction for a period of time. Another device in the prior art uses a solidified thermite mixture molded in the shape of the joint cavity to be welded. However, the prior art does not disclose a device designed to deposit the thermite mixture in a desired placement on top of a workpiece to be cut, wherein the user ignites the thermite after depositing it.

### BRIEF SUMMARY OF THE INVENTION

An embodiment of the disclosure meets the needs presented above by generally comprising a hollow tube containing a reactive substance comprising a mixture of a metallic oxide powder and a reducing agent such that a user can dispense the reactive substance. An electrical power module with an anode and a cathode is coupled to the tube, wherein the anode and the cathode are simultaneously positionable such that the anode is proximate the cathode and both the anode and the cathode abut the dispensed reactive substance, thereby igniting the reactive substance for cutting a workpiece.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a portable thermal cutting device according to an embodiment of the disclosure.

FIG. 2 is a top front side perspective view of an embodiment of the disclosure.

FIG. 3 is a cross-sectional front view of an embodiment of the disclosure.

FIG. 4 is an in-use view of an embodiment of the disclosure, wherein a user dispenses a reactive substance onto a piece of sheet metal.

FIG. 5 is an in-use view of an embodiment of the disclosure, wherein a user ignites the dispensed reactive substance using the power module.

FIG. 6 is an exploded top front side perspective view of an embodiment of the disclosure.

### DETAILED DESCRIPTION OF THE INVENTION

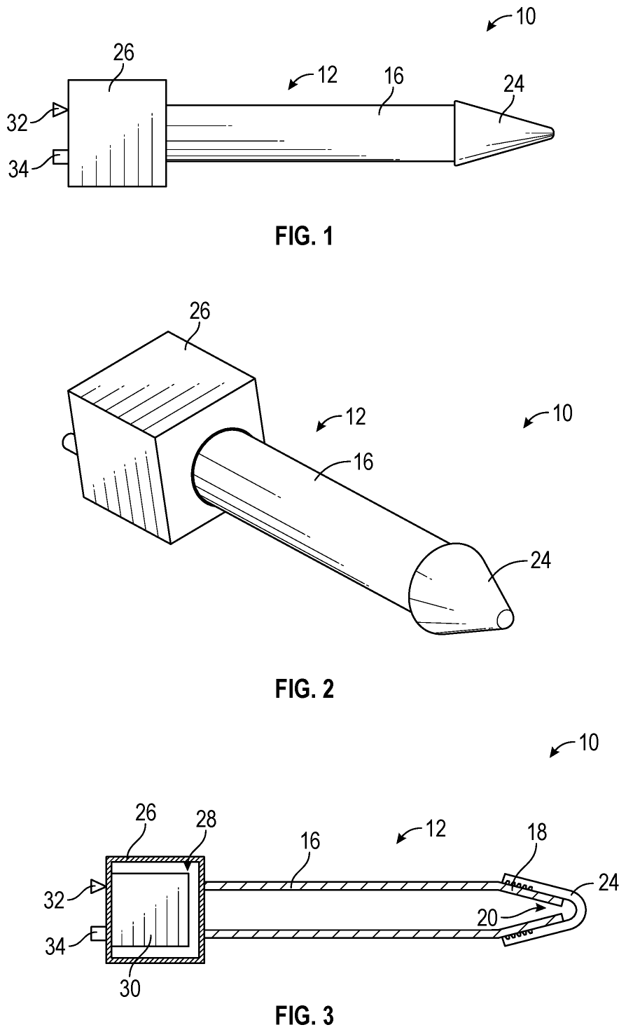

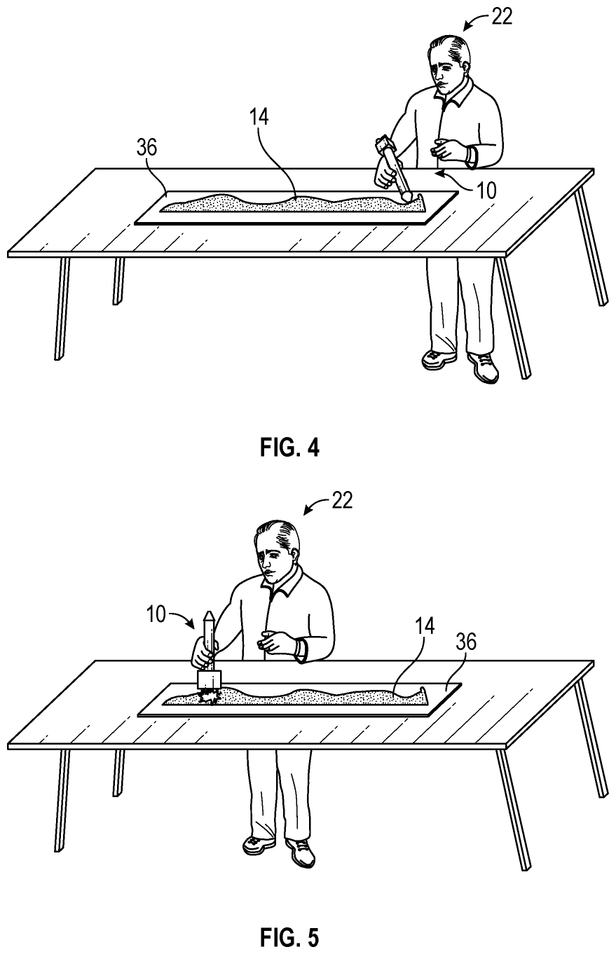

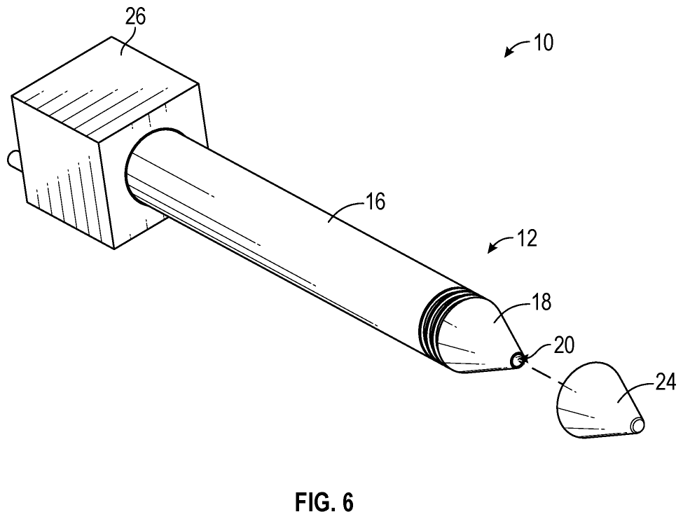

With reference now to the drawings, and in particular to FIGS. 1 through 6 thereof, a new chemical cutting device embodying the principles and concepts of an embodiment of the disclosure and generally designated by the reference numeral 10 will be described.

As best illustrated in FIGS. 1 through 6, the portable thermal cutting device 10 generally comprises a hollow tube 12 containing a reactive substance 14 comprising thermite. Thermite is a mixture of a metallic oxide and a reducing agent, often in powdered form, which undergoes an exothermic reduction-oxidation reaction when ignited that results in temperatures high enough to melt most metals. Thermite is used in many metal cutting and welding operations. The tube 12 has a cylindrical portion 16 coupled to a tapered portion 18, wherein the tapered portion 18 has a nozzle 20 opposite the cylindrical portion 16. The tube 12 is flexible and is configured for squeezing by a user 22 such that the tube 12 urges the reactive substance 14 through the nozzle 20. The tube 12 is externally threaded on the tapered portion 18 proximate to the cylindrical portion 16 and an internally threaded cap 24 is removably couplable to the tube 12, the tube 12 being complementary in shape to the tapered portion 18 of the tube 12. The cap 24 secures the reactive substance 14 within the tube 12 when the cap 24 is coupled to the tube 12.

A power module compartment 26 is coupled to the tube 12 opposite the nozzle 20 and defining an interior space 28. An electrical power module 30 comprising a 9-volt battery is partially positioned within the interior space 28 and is coupled to the power module compartment 26. The power module 30 has an anode 32 and a cathode 34, both of which protrude from the power module compartment 26 opposite the nozzle 20. the anode 32 and the cathode 34 are simultaneously positionable such that the anode 32 is proximate to the cathode 34 and both the anode 32 and the cathode 34 abut the dispensed reactive substance 14.

In use, a user 22 removes the cap 24 from the tube 12 and squeezes the reactive substance 14 in a desired placement on a piece of sheet metal 36 or other workpiece meant to be cut. The user 22 replaces the cap 24 onto the tube 12. Then the user 22 abuts the anode 32 and the cathode 34 of the power module 30 to the reactive substance 14 with the anode 32 proximate to the cathode 34. In this position, an electrical current flows between the anode 32 and the cathode 34 with nearly no resistance, which ignites an exothermic reaction in the reactive substance 14 which cuts through the sheet metal 36 or other workpiece along the desired placement of the reactive substance 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable thermal cutting device comprising:
a reactive substance comprising a mixture of a metallic oxide powder and a reducing agent;
a hollow tube containing the reactive substance, said tube being in environmental communication with an exterior space, said tube being configured for dispensing said reactive substance by a user onto a surface; and
an electrical power module coupled to said tube, said power module having an anode and a cathode, said anode and said cathode being simultaneously positionable such that said anode is proximate said cathode and both said anode and said cathode abut said dispensed reactive substance.

2. The device of claim 1, wherein said metallic oxide powder is an iron oxide powder.

3. The device of claim 1, wherein said reducing agent is an aluminum powder.

4. The device of claim 1, wherein said reactive substance comprises an adhesive.

5. The device of claim 1, wherein said reactive substance comprises a quantity of sodium nitrate.

6. The device of claim 1, wherein said tube has a cylindrical portion coupled to a tapered portion, said tapered portion having a nozzle opposite said cylindrical portion, said reactive substance being configured for dispensing by a user through said nozzle.

7. The device of claim 6, wherein said tube is flexible, said tube being configured for squeezing by a user such that said tube urges said reactive substance through said nozzle.

8. The device of claim 1, further comprising a cap, said cap being removably couplable to said tube, said cap securing said reactive substance within said tube when said cap is coupled to said tube.

9. The device of claim 1, further comprising a power module compartment coupled to said tube and defining an interior space, said power module being partially positioned within said interior space, said power module being coupled to said power module compartment, both said anode and said cathode protruding from said power module compartment.

10. The device of claim 1, wherein said power module comprises a 9-volt battery.

11. The device of claim 1, wherein said tube is constructed of vinyl.

12. A portable thermal cutting device comprising:
a reactive substance comprising a mixture of a metallic oxide powder and a reducing agent;
a hollow tube containing the reactive substance, wherein said tube has a cylindrical portion coupled to a tapered portion, said tapered portion having a nozzle opposite said cylindrical portion, wherein said tube is flexible, said tube being configured for squeezing by a user such that said tube urges said reactive substance through said nozzle, wherein said tube is externally threaded on said tapered portion proximate said cylindrical portion;
a cap being internally threaded and complementary in shape to said tapered portion of said tube, said cap being removably couplable to said tube, said cap securing said reactive substance within said tube when said cap is coupled to said tube;
a power module compartment coupled to said tube opposite said nozzle and defining an interior space; and
an electrical power module being partially positioned within said interior space, said power module being coupled to said power module compartment, said power module having an anode and a cathode, both said anode and said cathode protruding from said power module compartment opposite said nozzle, said anode and said cathode being simultaneously positionable such that said anode is proximate said cathode and both said anode and said cathode abut said dispensed reactive substance, wherein said power module comprises a 9-volt battery.
